(19) United States
(12) Patent Application Publication
(10) Pub. No.: US 2016/0079612 A1
(43) Pub. Date: Mar. 17, 2016

(54) Carbon Paper With Conducting Polymers And Polyols For Fuel Cell And Preparation Method Thereof

(71) Applicant: Korea Institute Of Energy Research, Daejeon (KR)

(72) Inventors: Hyunuk KIM, Daejeon (KR); Yoonjong YOO, Daejeon (KR); Young Ju LEE, Gyeongsangnam-do (KR)

(21) Appl. No.: 14/569,964

(22) Filed: Dec. 15, 2014

(30) Foreign Application Priority Data
Sep. 15, 2014 (KR) 10-2014-0122214

(51) Int. Cl. H01M 8/02; H01M 8/04

(52) U.S. Cl. CPC H01M 8/0234; H01M 8/04089; H01M 2250/30

(57) ABSTRACT

A carbon paper for fuel cells includes a conductive polymer and a polyol having at least two —OH functional groups, and a method for producing the same. The method for producing the carbon paper for fuel cells provides carbon paper with high electroconductivity even when a heat treatment is carried out at low temperature. In addition, the temperature for heat treatment is reduced significantly as compared to conventional carbon paper, and thus it is possible to reduce the overall cost required for producing carbon paper for fuel cells. Further, the carbon paper for fuel cells obtained by the method has high flexibility with low brittleness.

### CROSS-REFERENCE TO RELATED APPLICATIONS

This application claims priority under 35 U.S.C. §119 to Korean Patent Application No. 10-2014-0122214 filed on Sep. 15, 2014 in the Korean Intellectual Property Office, the disclosure of which is incorporated herein by reference in its entirety.

### TECHNICAL FIELD

The following disclosure relates to carbon paper including a conductive polymer and a polyol component for use in fuel cells and a method for producing the same.

### BACKGROUND

A fuel cell is a system by which chemical reaction energy between hydrogen and oxygen contained in hydrocarbon-based materials such as methanol, ethanol and natural gas is converted directly into electric energy.

Typical examples of a fuel cell system include polymer electrolyte fuel cells, direct oxidation fuel cells, or the like. Among those, polymer electrolyte fuel cells are clean energy sources capable of substituting for fossil fuel energy, have high output density and energy conversion efficiency, can be operated at room temperature, allow downsizing and encapsulation, and thus are used widely in pollution-free cars, household power generator systems, portable power sources for mobile communication devices and military devices.

A fuel cell is a device in which fuel (reducing agent) and oxygen or air (oxidizing agent) are supplied continuously from the exterior and are allowed to react with each other so that electric energy is output. In general, such fuel cells are classified depending on their operation temperatures, types of fuel used therein and their uses. However, more recently, fuel cells are generally classified, depending on types of electrolyte used therein, into the following five types: solid oxide fuel cells (SOFC), molten carbonate fuel cells (MCFC), phosphoric acid fuel cells (PAFC), polymer electrolyte fuel cells (PEFC) and aqueous alkaline solution fuel cells (AFC).

Although most fuel cells use hydrogen gas generated from methane as fuel, direct methanol fuel cells (DMFC) using aqueous methanol solution directly as fuel have been known more recently.

Among such fuel cells, many intentions have been given to solid polymer electrolyte fuel cells (also referred to as ‘polymer electrolyte fuel cells or PEFC) including an assembly having two types of electrodes and a solid polymer membrane inserted therebetween, wherein the assembly is inserted between separators.

Such a PEFC is obtained by disposing a cathode (oxygen electrode) and an anode (hydrogen electrode) at both sides of a solid polymer membrane to form a unit cell, and inserting the unit cell between separators for fuel cells. In such a PEFC, it is required to isolate fuel (hydrogen) from an oxidizing agent (air) so that they cannot react directly with each other, and to transfer protons produced at the anode to the cathode.

Since such a PEFC was developed first in the late 1950s by General Electric Co. (USA), it was mounted to the Gemini spacecraft. At the early stage of development, an ion exchange membrane based on a hydrocarbon was used. Then, Dupont Co. (USA) developed a fluororesin-based ion exchange membrane, Nafion, leading to significant improvement of the durability of a PEFC. At the early stage of development, PEFCs are for use in spacecraft or military applications. However, in early 1980s, Ballard Co. (Canada) started to develop PEFCs for use in public welfare applications. In early 1990s, Daimler-Benz AG developed a fuel cell car to which a PEFC obtained from Ballard Co. was mounted. Under these circumstances, PEFCs have been given many attentions all over the world.

Meanwhile, power generation in a PEFC is based on the following. A fluororesin-based ion exchange membrane that is a proton conductor is used as electrolyte generally, the electrolyte membrane is inserted between an anode and a cathode, each having a catalyst layer and a gas diffusion layer, and hydrogen-containing fuel and oxygen-containing oxidizing agent are supplied to the anode and the cathode, respectively. Then, a catalytic reaction occurs.

In such a PEFC having the above-mentioned construction, the gas diffusion layer uses carbon paper having a thickness of about 100-500 μm and provided with excellent gas permeability and electroconductivity.

In a method for producing carbon paper according to the related art, in the case of a wet-laid process for producing carbon paper, carbon fibers are dispersed into aqueous solution, passed through dehydration and papermaking steps using a wet-laid paper forming system, and dried to provide carbon fiber webs. The resultant carbon fiber webs are impregnated with a thermosetting resin, and cured by heating. After carbon sheets are formed through the curing step, the thermosetting resin in the sheets thus formed are subjected to defatting and high-temperature carbonization to complete production of carbon paper. Typical examples of the thermosetting resin with which the carbon fiber webs are impregnated include a phenol resin.

However, when carbon paper is produced by impregnating carbon fiber webs with a phenol resin that belongs to thermosetting resins, followed by high-temperature carbonization, production cost increases due to the heat treatment carried out at a high temperature of at least 1200° C. In addition, when using a phenol resin as a thermosetting resin, carbonization carried out at a temperature of at least 1200° C. after applying the phenol resin makes the resultant carbon paper brittle with ease.

### SUMMARY

An embodiment of the present disclosure is directed to providing carbon paper for fuel cells having high cost-efficiency and a method for producing the same. More particularly, an embodiment of the present disclosure is directed to providing a method for producing carbon paper for fuel cells which can provide carbon paper with high quality even when the heat treatment is carried out at a reduced temperature during the production of carbon paper, as well as carbon paper obtained thereby. Another embodiment of the present disclosure is also directed to providing carbon paper for fuel cells having excellent electroconductivity even though such a reduced temperature is used for the heat treatment. Still another embodiment of the present disclosure is also directed to providing carbon paper that has flexibility with low brittleness even after the heat treatment and thus is useful for a flexible and non-brittle capacitor electrode, as well as a method for producing the same.

In one general aspect, there is provided carbon paper for fuel cells, which includes a complex containing a conductive polymer material and a polyol component and is coated with the complex on the surface thereof.

In another general aspect, there is provided a method for producing carbon paper for fuel cells, including the steps of:
1) providing a mixed solution containing a conductive polymer material and a polyol component;
2) coating carbon paper for fuel cells with the mixed solution; and
3) heat treating the coated carbon paper.

The method for producing the carbon paper for full cells disclosed herein provides carbon paper with high electroconductivity even though the heat treatment is carried out at low temperature. In addition, the temperature for heat treatment is reduced significantly as compared to the conventional carbon paper, and thus it is possible to reduce the overall cost required for producing carbon paper. In addition, the carbon paper for fuel cells obtained by the method disclosed herein has high flexibility with low brittleness. Thus, the carbon paper for fuel cells is useful for flexible electrodes.

### BRIEF DESCRIPTION OF THE DRAWINGS

FIG. 1(a)-1(c) are photographs illustrating the surface image of carbon paper for fuel cells according to Example 1, with FIG. 1(a) being a surface image of carbon paper for fuel cells obtained by using PEDOT:PSS only, without ethylene glycol or glycerol, FIG. 1(b) being a surface image of carbon paper for fuel cells obtained by using a complex of PEDOT:PSS with ethylene glycol, and FIG. 1(c) being a surface image of carbon paper for fuel cells obtained by using a complex of PEDOT:PSS with glycerol.

FIG. 2 shows electric resistance values of carbon paper for fuel cells including a mixture containing ethylene glycol and glycerol added to PEDOT:PSS while varying the added amount (triangles: ethylene glycol (EG), squares: glycerol (Gly)).

FIG. 3 is a graph of the XRD pattern of carbon paper for fuel cells according to Example 1.

FIGS. 4(a) through 4(f) are photographs illustrating the SEM image of carbon paper for fuel cells containing a mixture obtained by adding ethylene glycol (EG) to a mixture of PEDOT:PSS with conductive graphite powder while increasing the added amount, with FIG. 4(a) adding 2 wt % EG, FIG. 4(b) 5 wt % EG, FIG. 4(c) 10 wt % EG, FIG. 4(d) 20 wt % EG, FIG. 4(e) 30 wt % EG, and FIG. 4(f) 40 wt % EG.

FIG. 5 shows electric resistance values of carbon paper for fuel cells containing a mixture obtained by adding ethylene glycol to a mixture of PEDOT:PSS with conductive graphite powder while increasing the added amount.

FIG. 6 is a graph illustrating electric resistance of carbon paper for fuel cells according to Example 2 as a function of heat treatment temperature.

FIGS. 7(a) through 7(d) are electron microscopic images of carbon paper for fuel cells obtained by varying heat treatment temperature when using ethylene glycol as a polyol component according to Example 2, FIG. 7(a) at 100° C., FIG. 7(b) at 150° C., FIG. 7(c) at 200° C. and FIG. 7(d) at 250° C.

FIGS. 8(a) through 8(d) are electron microscopic images of carbon paper for fuel cells obtained by varying heat treatment temperature when using glycerol as a polyol component according to Example 2, FIG. 8(a) at 100° C., FIG. 8(b) at 150° C., FIG. 8(c) at 200° C. and FIG. 8(d) at 250° C.

FIG. 9 is a graph illustrating the electroconductivity of each of Example 2 and the Comparative Example.

FIGS. 10(a) and 10(b) are photographs illustrating the measurement of flexibility of each of Example 2 and the Comparative Example.

FIG. 11 is a photograph illustrating the electric resistance of carbon paper obtained according to Example 2 before (closed circles) and after folding (open circles).

FIG. 12 is a photograph illustrating the quality of a hydrogen fuel cell using the carbon paper according to Example 2 under the conditions of 70° C. and a relative humidity of 100%.

### DETAILED DESCRIPTION OF EMBODIMENTS

The inventors of the present disclosure have conducted many studies in order to develop carbon paper for fuel cells having excellent electroconductivity even after carrying out heat treatment at low temperature. As a result, carbon paper for fuel cells and a method for producing the same disclosed herein have been found, thereby completing the present disclosure.

In one aspect, there is provided carbon paper for fuel cells, which includes a complex containing a conductive polymer material and a polyol component and is coated with the complex on the surface thereof.

In general, carbon paper for fuel cells is coated with a thermosetting resin and is used after curing the resin. However, in the case of such carbon paper coated with a thermosetting resin to be cured, heat treatment is carried out at a high temperature of 1,200° C. or higher. When using such a high-temperature condition, there is a problem in that the overall production cost of carbon paper for fuel cells excessively increases. In addition, since heat treatment or firing is carried out at an excessively high temperature, the resultant carbon paper for fuel cells has significantly insufficient flexibility and high brittleness. To solve such problems, it is required that the carbon paper for fuel cells is heat treated at low temperature, is provided with flexibility, and maintains high electroconductivity, which is the most important property of carbon paper for fuel cells, even after the heat treatment at low temperature.

The carbon paper for fuel cells disclosed herein solves the above-mentioned problems, and thus allows heat treatment at low temperature. In addition, the carbon paper for fuel cells disclosed herein has high electroconductivity even after the heat treatment at low temperature. Further, the carbon paper for fuel cells is provided with flexibility, and thus shows low brittleness.

Preferably, the conductive polymer material is PEDOT (poly(3,4-ethylenedioxythiophene)):PSS (poly(styrenesulfonate)) or a derivative thereof. The PEDOT:PSS or a derivative thereof is a conductive polymer material, significantly reduces heat treatment or firing temperature when it is coated on carbon paper for fuel cells, as compared to the conventional thermosetting resin such as a phenolic resin, and allows maintenance of high electroconductivity. Meanwhile, the PEDOT:PSS has a structure represented by the following Chemical Formula 1.

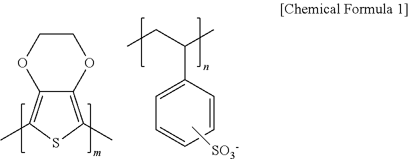

In addition, the polyol component has a plurality of —OH functional groups and preferably includes ethylene glycol, glycerol or a mixture of ethylene glycol and glycerol.

When using PEDOT:PSS or a derivative thereof as a conductive polymer material and ethylene glycol, glycerol or a mixture of ethylene glycol with glycerol as a polyol component as described above, a complex is formed on the surface of carbon paper for fuel cells and the surface of carbon paper for fuel cells is coated with the complex, it is possible to reduce heat treatment temperature as compared to carbon paper for fuel cells coated with PEDOT:PSS alone, while maintaining high electroconductivity. Further, in this case, it is possible to provide carbon paper for fuel cells with flexibility.

In addition to PEDOT:PSS, the compounds known as conductive polymers to date include polypyrrole, polyacetylene, polyaniline (PANI), polythiophene, polypyrrol and derivatives thereof. However, only PEDOT:PSS or a derivative thereof forms a reactive complex with ethylene glycol, glycerol or a mixture of ethylene glycol with glycerol as a polyol component, thereby allowing maintenance of high electroconductivity.

The complex preferably includes 5-100 parts by weight of the polyol component based on 100 parts by weight of the conductive polymer material. When the polyol component is used in an amount less than 5 parts by weight, it is difficult to reduce heat treatment temperature significantly. When the polyol component is used in an amount greater than 100 parts by weight, the electroconductivity to be accomplished through the conductive polymer material may be limited undesirably. In addition, the complex within the above-defined range allows maintenance of electroconductivity while providing carbon paper for fuel cells with flexibility. Thus, the carbon paper for fuel cells thus provided with flexibility may be useful for a flexible capacitor electrode or the like.

In addition, the carbon paper for fuel cells may be heat treated at a temperature of 50-300° C. Such low-temperature heat treatment results from the fact that the carbon paper for fuel cells is coated with a mixture of a conductive polymer material with a polyol component. Meanwhile, heat treatment may be carried out 100-250° C., more preferably. When carrying out heat treatment at this temperature range, agglomeration may not occur.

In addition, the carbon paper for fuel cells has an electroconductivity of 3-1,000 mΩ/cm². Thus, the electroconductivity required for carbon paper for fuel cells to function well is maintained similarly to the conventional carbon paper for fuel cells using a phenolic resin.

Further, the complex is coated with a thickness of 10-500 μm. When the coating thickness is less than 10 μm, it is not possible to reduce heat treatment temperature sufficiently. When the coating thickness is greater than 500 μm, carbon paper for fuel cells have an excessively large thickness, resulting in undesired loss of the air-tight property of a fuel cell.

Meanwhile, the carbon paper for fuel cells disclosed herein may further include conductive graphite powder in addition to the complex. When using conductive graphite powder additionally, the carbon paper for fuel cells disclosed herein shows reduced contact resistance, resulting in improvement of electroconductivity. Herein, graphite powder may be used in an amount of 5-50 parts by weight based on 100 parts by weight of the conductive polymer material. When graphite powder is used in an amount less than 5 parts by weight, it is not possible to improve electroconductivity sufficiently. When graphite powder is used in an amount greater than 50 parts by weight, it may block the pores of carbon paper, resulting in degradation of the air permeability.

In another aspect, there is provided a method for producing carbon paper for fuel cells, including the steps of:

1) providing a mixed solution containing a conductive polymer material and a polyol component;

2) coating carbon paper for fuel cells with the mixed solution; and

3) heat treating the coated carbon paper.

Preferably, the conductive polymer material is PEDOT (poly(3,4-ethylenedioxythiophene):PSS (poly(styrenesulfonate)) or a derivative thereof.

In addition, the polyol component is a component added to the conductive polymer to reduce the resistance of carbon paper, and preferably includes polyols having a plurality of —OH functional groups, such as ethylene glycol, glycerol or a mixture of ethylene glycol and glycerol.

In step 1), the conductive polymer material and the polyol component are used preferably at a ratio of 5-100 parts by weight of the polyol component based on 100 parts by weight of the conductive polymer material. When the polyol component is used in an amount less than 5 parts by weight, it is not possible to reduce heat treatment temperature sufficiently. When the polyol component is used in an amount greater than 100 parts by weight, electroconductivity to be accomplished through the conductive polymer material may be limited undesirably. In addition, the complex within the above-defined range allows maintenance of electroconductivity while providing carbon paper for fuel cells with flexibility. Thus, the carbon paper for fuel cells thus provided with flexibility may be useful for a flexible capacitor electrode or the like.

In addition, in step 2), the coating may be carried out preferably by at least one process selected from the group consisting of spin coating, dip coating, vacuum filtration, thin film coating and spray coating.

Further, in step 2), the coating may be carried out preferably with a thickness of 10-500 μm.

In step 3), the heat treatment may be carried out preferably at a temperature of 50-300° C. Such low-temperature heat treatment results from the fact that the carbon paper for fuel cells is coated with a mixture of a conductive polymer material with a polyol component. Meanwhile, heat treatment may be carried out 100-250° C., more preferably. When carrying out heat treatment at this temperature range, agglomeration may not occur.

In addition, the carbon paper for fuel cells obtained by the above-described method may have an electroconductivity of 3-1,000 mΩ/cm².

Meanwhile, in step 1), the mixed solution may further include conductive graphite powder and carbon paper for fuel cells may be obtained by using the mixed solution. When the mixed solution in step 1) further includes conductive graphite powder, the carbon paper for fuel cells disclosed herein shows improved electroconductivity. In step 1), graphite powder may be used in an amount of 5-50 parts by weight based on 100 parts by weight of the conductive polymer material.

Thus, when producing carbon paper for fuel cells by the method disclosed herein, it is possible to reduce heat treatment temperature, to maintain high electroconductivity, and to provide carbon paper for fuel cells with flexibility so that the carbon paper for fuel cells may not be broken with ease. Additionally, it is possible to obtain carbon paper for fuel cells having excellent moisture-absorbing property.

As a result, the carbon paper for fuel cells disclosed herein and the same obtained by the method disclosed herein are useful for fuel cells.

The examples and experiments will now be described. The following examples and experiments are for illustrative purposes only and not intended to limit the scope of this disclosure.

### EXAMPLES

### Example 1

To 5 g of PEDOT:PSS as a conductive polymer, 2-40 parts by weight of ethylene glycol or glycerol is added to provide mixed solutions. Then, each mixed solution is applied onto carbon fiber web for fuel cells (self-produced as disclosed in Korean Patent Publication No. 10-1304489) and heat treated at 100° C. for 2 hours to obtain carbon paper. In this manner, carbon paper for fuel cells having high conductivity is obtained.

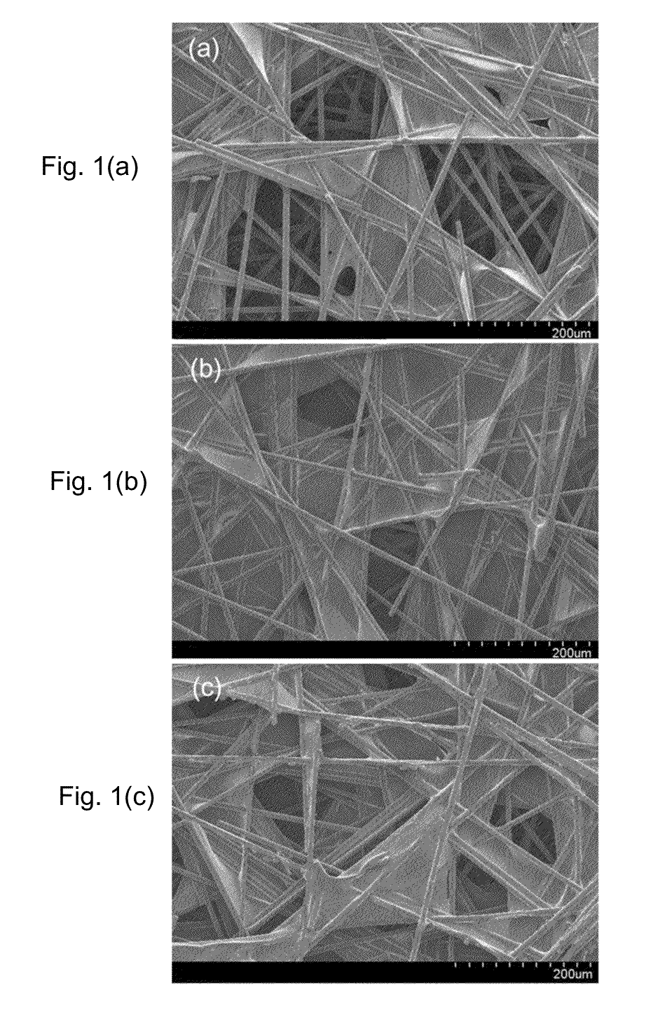

Meanwhile, FIGS. 1(a)-1(c) show images of different types of carbon paper for fuel cells according to Example 1, wherein FIG. 1(a) illustrates carbon paper for fuel cells obtained by using PEDOT:PSS only without ethylene glycol or glycerol. In addition, FIG. 1 (b) illustrates carbon paper for fuel cells obtained by using a complex of PEDOT:PSS with ethylene glycol. Further, FIG. 1(c) illustrates carbon paper for fuel cells obtained by using a complex of PEDOT:PSS with glycerol.

Meanwhile, the following Table 1 shows the thickness, resistance (ASR at 1 bar) and air permeability of each of the carbon paper for fuel cells using PEDOT:PSS only (PEDOT:PSS), carbon paper for fuel cells using a complex of PEDOT:PSS with ethylene glycol (PEDOT:PSS-EG^{a}), and carbon paper for fuel cells using a complex of PEDOT:PSS with glycerol (PEDOT:PSS-Gly^{a}). As shown in Table 1, addition of ethylene glycol or glycerol significantly reduces resistance as compared to the carbon paper for fuel cells using neither ethylene glycol nor glycerol, resulting in improvement of electroconductivity.

TABLE 1

| | Thickness | ASR at 1 bar | Air permeability |
|---|---|---|---|
| CPs | (μm) | (mΩ · cm²) | (ml/min/cm²) |
| pristine | 127 | 823 | 69570 |
| PEDOT:PSS | 134 | 1412 | 37244 |
| PEDOT:PSS-EG^{a} | 115 | 94 | 22912 |
| PEDOT:PSS-Gly^{a} | 119 | 90 | 28058 |

^{a}Addition of 10 wt % EG or Gly

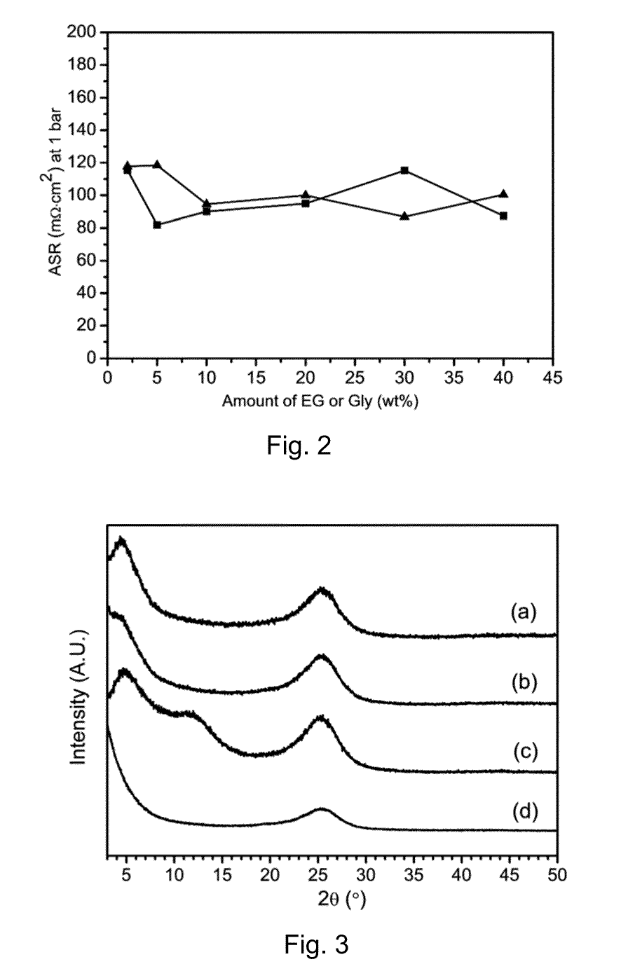

Meanwhile, FIG. 2 shows resistance values of carbon paper for fuel cells as a function of amount of ethylene glycol or glycerol added thereto according to Example 1.

In addition, FIG. 3 (XRD profiles of (a) carbon paper (CP) with PEDOT:PSS-Gly, (b) CP with PEDOT:PSS-EG, (c) CP with PEDOT:PSS, and (d) pristine CP) shows a graph of XRD patterns of each type of CP for fuel cells. As shown in FIG. 3, it can be seen from the characteristic peak at 12° observed in the carbon paper coated with PEDOT:PSS (graph (c)) but not observed in graphs (a) and (b) with glycerol and ethylene glycol added thereto that a phase change occurs after the addition of glycerol and ethylene glycol.

### Example 2

To 5 g of PEDOT:PSS as a conductive polymer, 10 parts by weight of conductive graphite powder (GP) is dispersed and 2-40 parts by weight of ethylene glycol or glycerol is added to provide mixed solutions. Then, each mixed solution is applied onto carbon fiber web for fuel cells (self-produced as disclosed in Korean Patent Publication No. 10-1304489) and heat treated at 100° C. for 2 hours to obtain carbon paper. In this manner, carbon paper for fuel cells having high conductivity is obtained.

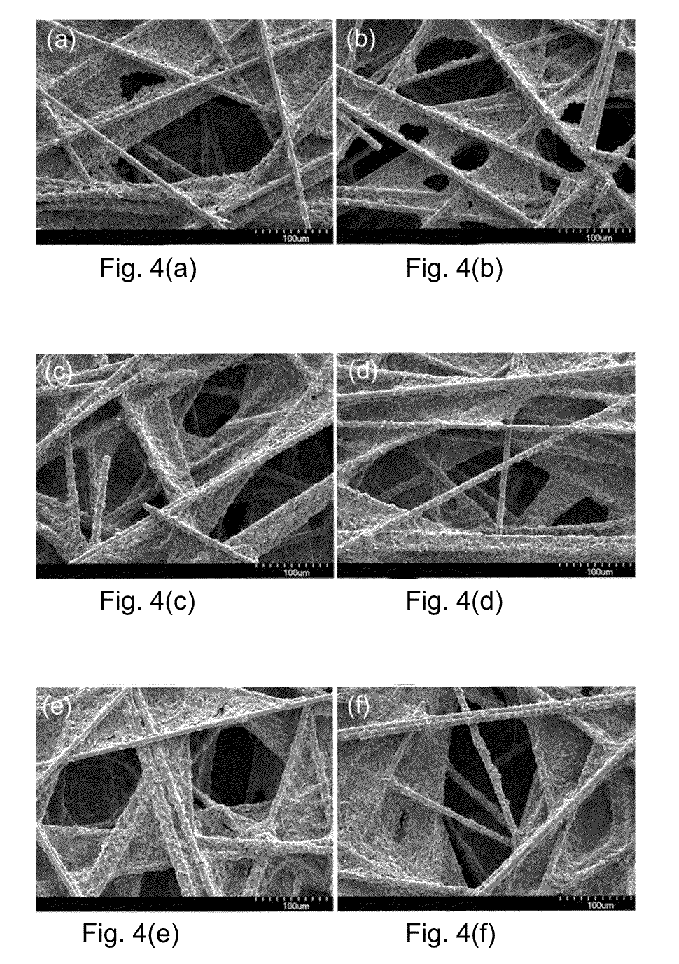

Meanwhile, FIGS. 4(a) through 4(f) show SEM images of carbon paper for fuel cells depending on an increase in amount of ethylene glycol, when carbon paper for fuel cells is obtained by using a mixture of PEDOT:PSS with conductive graphite powder while increasing addition of ethylene glycol (FIG. 4(a) 2 wt % EG, FIG. 4(b) 5 wt % EG, FIG. 4(c) 10 wt % EG, FIG. 4(d) 20 wt % EG, FIG. 4(e) 30 wt % EG, and FIG. 4(f) 40 wt % EG).

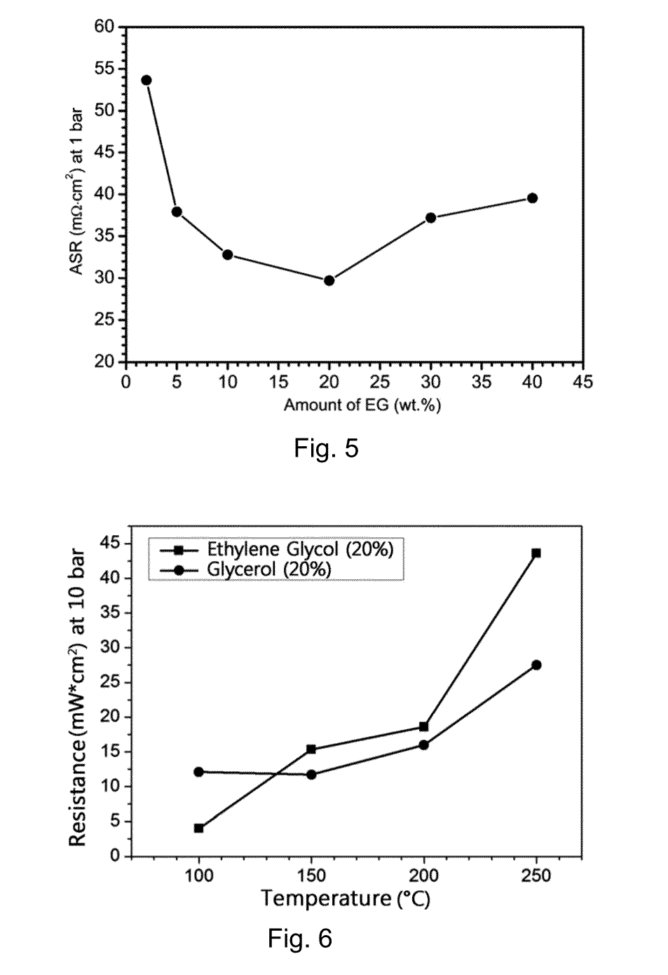

In addition, FIG. 5 is a graph illustrating a change in resistance value of carbon paper for fuel cells of Example 2 depending on an increase in amount of ethylene glycol. It can be seen from FIG. 5 that addition of ethylene glycol causes a significant drop in resistance value.

Meanwhile, FIG. 6 is a graph illustrating electric resistance as a function of heat treatment temperature in the carbon paper for fuel cells according to Example 2. It can be seen from FIG. 6 that the carbon paper for fuel cells obtained according to Example 2 provides reduces electric resistance.

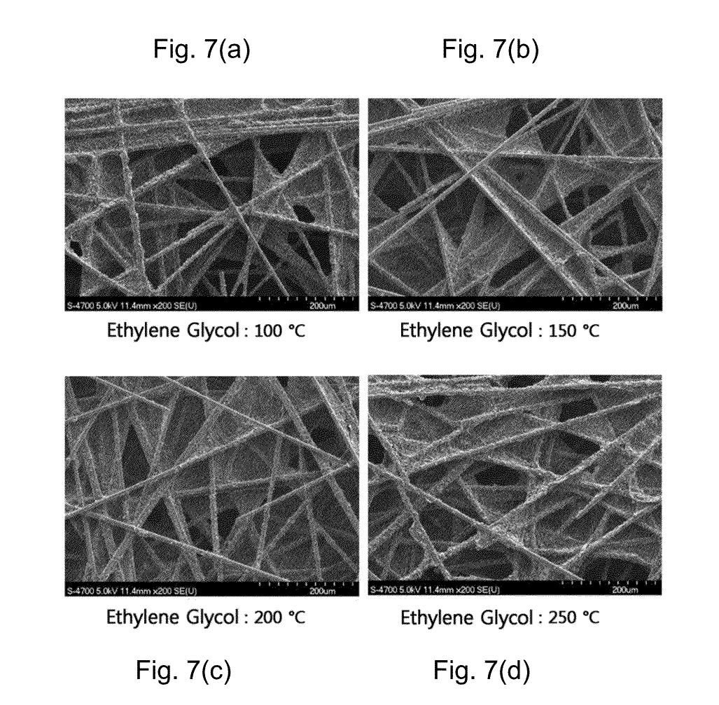

In addition, FIGS. 7(a) through 7(d) are electron microscopic images of carbon paper for fuel cells obtained by using ethylene glycol as a polyol component according to Example 2 while varying heat treatment temperature.

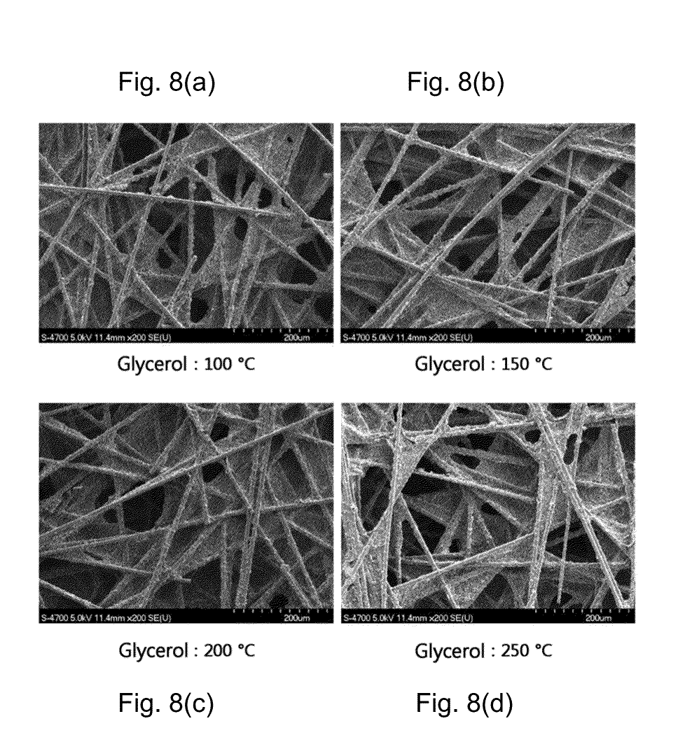

Further, FIGS. 8(a) through 8(d) are electron microscopic images of carbon paper for fuel cells obtained by using glycerol as a polyol component according to Example 2 while varying heat treatment temperature.

It can be seen from the results of FIG. 7 and FIG. 8 that when using ethylene glycol or glycerol as a polyol component as in Examples, heat treatment may be carried out at a lower temperature as compared to the conventional heat treatment while providing excellent results. However, as shown in FIG. 7 and FIG. 8, slight agglomeration may occur at approximately 250° C.

### Comparative Example

A phenolic resin (KRD-HM2 available from Kolon) is used as a curable resin and 10 parts by weight of graphite powder is added thereto to provide a mixed solution. Each mixed solution is applied onto carbon fiber web for fuel cells (self-produced as disclosed in Korean Patent Publication No. 10-1304489) and carbonized at 1,200° C. for 2 hours to obtain finished carbon paper for fuel cells.

### Test Examples

### Test Example 1

### Determination of Electroconductivity

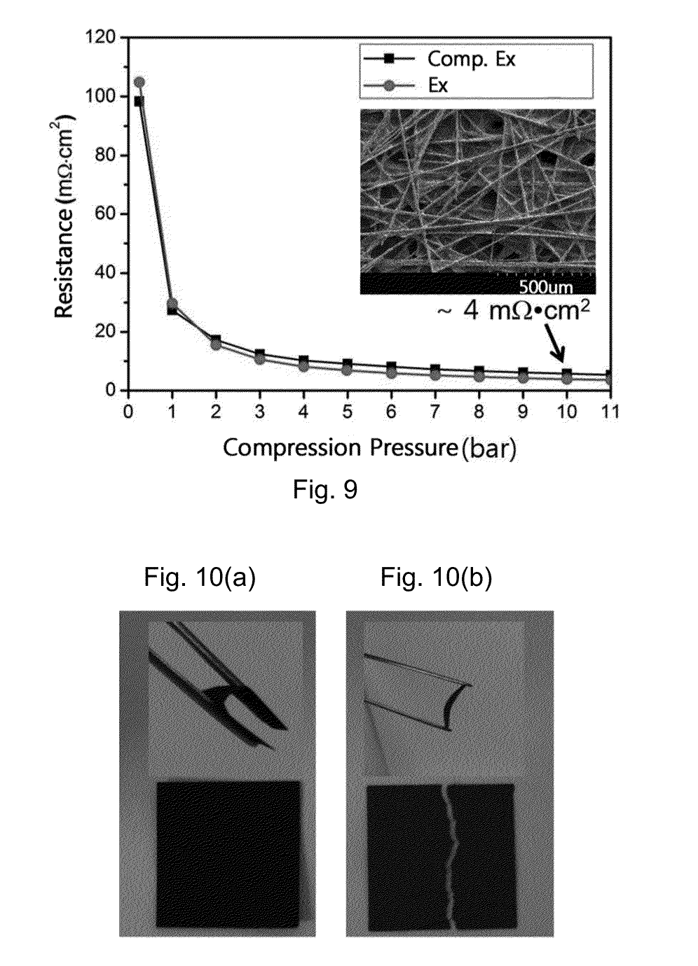

A test is carried out to compare the electroconductivity of Examples with that of Comparative Example. The test is carried out by placing doughnut-like carbon paper (4.799 cm²) between gold electrodes and increasing the pressure applied to the electrodes. The results are shown in FIG. 9.

FIG. 9 shows the electroconductivity of Example 2 and that of Comparative Example. In the case of Example 2, the electroconductivity is higher as compared to the Comparative Example using a phenolic resin as a conventional thermosetting coating material.

### Test Example 2

### Determination of Flexibility

Each carbon paper for fuel cells according to Example 2 and Comparative Example is determined whether it has flexibility or not. The test is carried out by pressing both ends of carbon paper with a pair of tweezers and observing whether any crack or failure occurs or not. The results are shown in FIGS. 10(a) and 10(b). As can be seen from FIG. 10(a), Example 2 shows flexibility with low brittleness under a certain degree of external force. However, the Comparative Example (FIG. 10(b) is broken with ease even though the extent of external force applied through a pair of tweezers is smaller as compared to Example 2, suggesting that the carbon paper for fuel cells according to Example 2 has good flexibility. The fact that the external force applied to Example 2 is larger than the external force applied to Comparative Example can be determined from FIG. 10 in which the separation degree of the tweezers is larger in the case of Comparative Example.

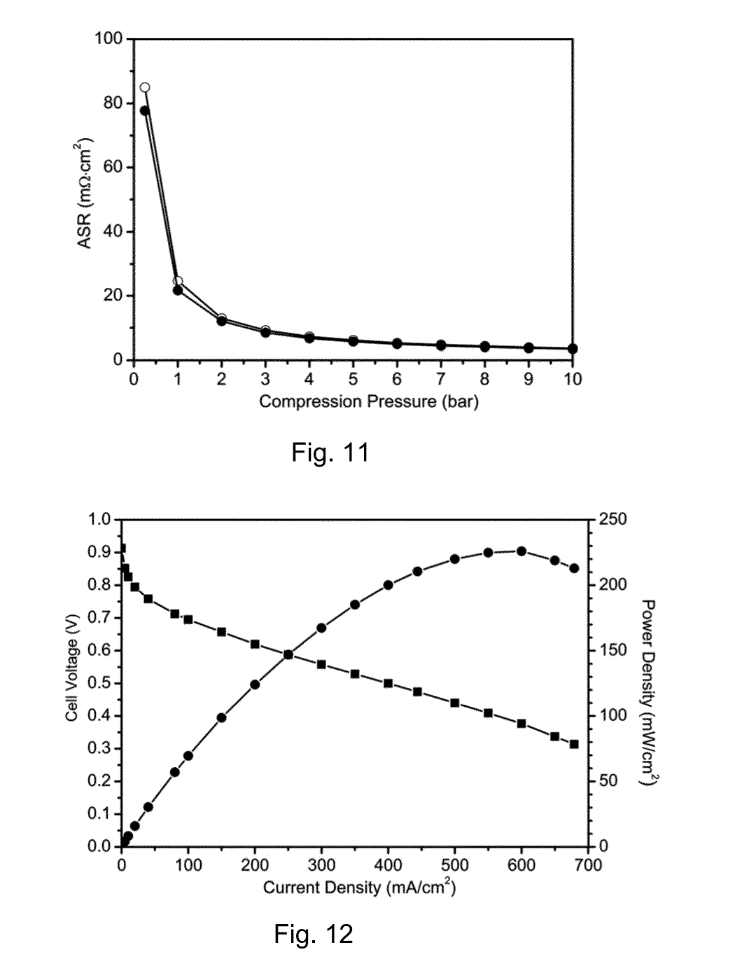

Meanwhile, FIG. 11 shows the electric resistance value of Example 2 determined after folding the carbon paper in half completely as shown in portion (a) of FIG. 10. It can be seen that there is no change in electric resistance before (closed circles) and after (open circles) folding.

FIG. 12 shows the results of a test for determining the quality of a unit cell using the carbon paper obtained according to Example 2 as a gas diffusion layer for hydrogen fuel cells, as measured at 70° C. under a relative humidity of 100%.

While the present disclosure has been described with respect to the specific embodiments, it will be apparent to those skilled in the art that various changes and modifications may be made without departing from the spirit and scope of the disclosure as defined in the following claims.

What is claimed is:

1. Carbon paper for fuel cells which comprises a complex containing a conductive polymer material and a polyol component, the carbon paper being coated with the complex on a surface thereof.

2. The carbon paper for fuel cells according to claim 1, wherein the conductive polymer material is PEDOT (poly(3,4-ethylenedioxythiophene)):PSS (poly(styrenesulfonate)) or a derivative thereof.

3. The carbon paper for fuel cells according to claim 1, wherein the polyol component has a plurality of —OH functional groups.

4. The carbon paper for fuel cells according to claim 1, wherein the polyol component is ethylene glycol, glycerol or a mixture of ethylene glycol and glycerol.

5. The carbon paper for fuel cells according to claim 1, wherein the complex comprises 5-100 parts by weight of the polyol component based on 100 parts by weight of the conductive polymer material.

6. The carbon paper for fuel cells according to claim 1, which has been heat treated at a temperature of 50-300° C.

7. The carbon paper for fuel cells according to claim 1, which has an electroconductivity of 3-1,000 mΩ/cm².

8. The carbon paper for fuel cells according to claim 1, wherein the coating has a thickness of 10-500 μm.

9. The carbon paper for fuel cells according to claim 1, wherein the complex further comprises graphite powder.

10. The carbon paper for fuel cells according to claim 9, wherein the complex comprises 5-50 parts by weight of graphite powder based on 100 parts by weight of the conductive polymer material.

11. A method for producing carbon paper for fuel cells, comprising the steps of:
1) providing a mixed solution containing a conductive polymer material and a polyol component;
2) coating carbon paper for fuel cells with the mixed solution; and
3) heat treating the coated carbon paper.

12. The method for producing carbon paper for fuel cells according to claim 11, wherein the conductive polymer material is PEDOT (poly(3,4-ethylenedioxythiophene)):PSS (poly(styrenesulfonate)) or a derivative thereof.

13. The method for producing carbon paper for fuel cells according to claim 11, wherein the polyol component has a plurality of —OH functional groups.

14. The method for producing carbon paper for fuel cells according to claim 11, wherein the polyol component is ethylene glycol, glycerol or a mixture of ethylene glycol and glycerol.

15. The method for producing carbon paper for fuel cells according to claim 11, wherein the mixed solution of step 1) comprises 5-100 parts by weight of the polyol component based on 100 parts by weight of the conductive polymer material.

16. The method for producing carbon paper for fuel cells according to claim 11, wherein the heat treatment of step 3) is carried out at a temperature of 50-300° C.

17. The method for producing carbon paper for fuel cells according to claim 11, wherein the carbon paper for fuel cells obtained by the method has an electroconductivity of 3-1,000 mΩ/cm².

18. The method for producing carbon paper for fuel cells according to claim 11, wherein the coating in step 2) has a thickness of 10-500 μm.

19. The method for producing carbon paper for fuel cells according to claim 11, wherein the mixed solution of step 1) further comprises graphite powder.

20. The method for producing carbon paper for fuel cells according to claim 19, wherein the mixed solution of step 1) comprises 5-50 parts by weight of graphite powder based on 100 parts by weight of the conductive polymer material.
